(19) United States
(12) Patent Application Publication
(10) Pub. No.: US 2005/0244669 A1
(43) Pub. Date: Nov. 3, 2005

(54) Laminated block with segment sheets connected by high-temperature soldering

(75) Inventor: Bernd Krause, Frankfurt/M. (DE)

Correspondence Address: THE WEBB LAW FIRM, P.C., 700 KOPPERS BUILDING, 436 SEVENTH AVENUE, PITTSBURGH, PA, 15219, US

(73) Assignee: Linde Aktiengesellschaft, Wiesbaden (DE)

(21) Appl. No.: 11/110,639

(22) Filed: Apr. 20, 2005

(30) Foreign Application Priority Data
Apr. 22, 2004 (DE) 10 2004 019 553.6

(51) Int. Cl. B32B 15/00

(52) U.S. Cl. 428/635; 428/679

(57) ABSTRACT

This invention relates to a laminated block, in particular a hydraulic control valve block, having a plurality of segmental plates (S1-S26) that are stacked one on top of another and are connected to one another. To easily and economically increase the strength of the laminated block, in particular with respect to pressure loads that are exerted as pulses and to expand the range of its potential applications, the segmental plates (S1-S26) are adhesively connected to one another by high-temperature soldering by nickel solder. Prior to the soldering, the nickel solder is located on the surface of the segmental plates (S1-S25).

### CROSS-REFERENCE TO RELATED APPLICATION

This application claims priority to German Application No. 10 2004 019 553.6 filed Apr. 22, 2004, which is herein incorporated by reference in its entirety.

### BACKGROUND OF THE INVENTION

1. Field of the Invention

This invention relates to a laminated block, in particular a hydraulic control valve block, having a plurality of segmental core discs that are stacked one on top of another and are connected with one another.

2. Technical Considerations

A laminated block of the known art is disclosed in DE 199 29 828 A1. In that laminated block, solder material is located in repository spaces. During the soldering process, the solder flows by capillary action through solder flow paths into the spaces between the segmental core discs, where it solidifies and thereby permanently connects the segmental core discs to one another. Laminated blocks of this type can be used as hydraulic directional control valves, for example.

In tests with generic laminated blocks in the form of control valve blocks, it has been determined that their maximum allowable pressure load, in particular with respect to pressure pulses, is to some extent significantly lower than the maximum allowable pressure load of valve blocks that are manufactured in the conventional manner, namely by casting. The range of use of such laminated blocks is, therefore, limited.

An object of this invention is to use simple and economical means to provide a laminated control block of the type generally described above but having increased strength, in particular with respect to pressure loads that are exerted in the form of pulses, so that the laminated block has an expanded range of potential uses.

### SUMMARY OF THE INVENTION

In one laminated block, for example a laminated hydraulic control valve block, the segmental plates are adhesively connected to one another by high-temperature soldering using nickel solder. Prior to the soldering, the nickel solder is located flat on the segmental plates.

One non-limiting aspect of the invention includes the deposition of the solder material on the surface of the segmental plates combined with the use of a solder material in which nickel or a nickel alloy forms the predominant element, and which is processed by means of high-temperature soldering, i.e., at temperatures of more than 900° C.

Compared to other solder materials, nickel has an elevated strength (approximately twice as high as copper solder) and a higher capillary action. Nickel solder is also very dimensionally stable, i.e., when it is used in excess quantities, it does not close any channels inside the laminated block because it is less runny than other solder materials, such as copper solder, for example. Finally, nickel solder also has good resistance to corrosion.

The allowable maximum pressure load that can be exerted on a laminated block realized in the form of a hydraulic control valve block and manufactured as taught by the invention is higher by 100 to 150 bar than the maximum allowable pressure load that can be exerted on a laminated block, the segmental plates of which are connected to one another using a copper-based solder material.

On account of the high intrinsic hardness of the nickel solder used in accordance with the invention, it is also not necessary to harden the walls of borings that are machined into the laminated block and are provided to receive longitudinally-sliding pistons or rotary-sliding pistons. The hardened nickel solder that is located in the joints thereby functions as a “hard” guide for the pistons. The segmental plates themselves can therefore be made of plain carbon steel, which is more economical than hardenable or heat-treatable alloy steels.

With regard to reducing the effort and expense required for the manufacture of the laminated block of the invention, it has been found to be advantageous if the nickel solder is applied to at least one side of the segmental plates in the form of a paste using a screen printing method.

This method is appropriate for series production. The quantity of solder material to be applied can thereby be regulated easily by the mesh width in the screen. On the laminated block of the invention, it is thereby possible to achieve a very uniform thickness of the joints and thus a high degree of dimensional accuracy in terms of the height of the laminated block. When the laminated block is used as a control valve, the internal control surfaces generally do not have to be subjected to a second machining or finishing operation.

Nevertheless, it is basically also possible to locate the solder material in the form of a film between the segmental plates.

In one particularly advantageous development of the invention, between the segmental plates that are adhesively connected to one another, there is a solder joint thickness in the range of 10 to 30 microns, such as approximately 20 microns. At this thickness, the strength of the adhesive connection reaches its maximum.

If a segmental plate that is used as the bottom cover plate has at least two vertical fixing pins that are in sliding engagement with aligned fixing borings in the subsequent segmental plates, there are simple means to create an effective device that assists in achieving proper positioning in the horizontal direction, by means of which lateral drifting of the segmental plates during soldering can be prevented. In this case, the clearance between the fixing pins and the fixing borings should be designed so that the upper segmental plates can move to some extent when the solder liquefies.

The fixing pins can be advantageously caulked with the bottom segmental plate, as a result of which their vertical orientation is retained during the stacking of the segmental plates.

With regard to the simple manufacturing of the segmental plates (for example by laser cutting) and a high allowable maximum pressure load of the finished laminated block, the segmental plates can be advantageously made of tempered steel. For example, a plain carbon tempered steel, such as C45 steel or similar steels, can be used for this purpose.

For the finishing or subsequent machining of the laminated block that follows the soldering process (e.g., precision machining of borings), it is appropriate if at least one side wall of the laminated block has a stop that is provided to make contact against a chucking device and acts in the vertical direction, which stop is located between the top and bottom of the laminated block. A stop of this type can therefore be used in two directions, i.e., even if the laminated block is turned upside down.

### BRIEF DESCRIPTION OF THE DRAWINGS

Additional advantages and details of the invention are explained in greater detail below with reference to the exemplary embodiment illustrated in the accompanying schematic drawings, in which like reference numbers identify like parts throughout.

FIG. 1 is a side view of a laminated block incorporating features of the invention; and

FIG. 2 is a view in perspective of the laminated block illustrated in FIG. 1.

### DESCRIPTION OF THE PREFERRED EMBODIMENTS

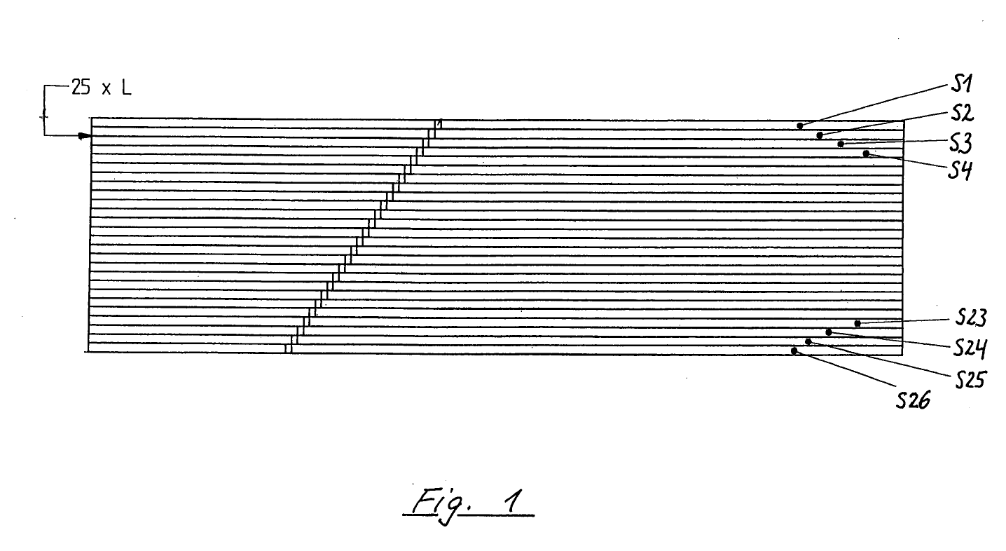

An exemplary laminated block of the invention can be in the form of a hydraulic control valve block. In the illustrated exemplary embodiment, the laminated block comprises a plurality, e.g., 26, segmental plates S1-S26 (shown in FIG. 1) which can be made of C45 steel. The external and internal contours of the plates S1-S26 can be produced by laser cutting. Of course the number of segmental plates can vary within a very wide range. Between the segmental plates S1-S26 there are a plurality, e.g., 25, solder seams L, each with a solder seam thickness in the range of 10 microns to 30 microns, such as 20 microns each.

The solder material comprises nickel solder, i.e., a solder whose primary ingredient is nickel or a nickel alloy. Before the soldering, this nickel solder is applied to at least one side of each of the segmental plates S1-S26, for example by means of a screen printing process. In this case, the solder is in the form of a paste, i.e., in the form of a powder which is embedded in a binding agent. The nickel solder is located flat on the segmental plates prior to soldering. The adhesive connection between the segmental plates S1-S26 can be accomplished by high-temperature soldering in a vacuum furnace. Temperatures of more than 900° C. are typically achieved during this process.

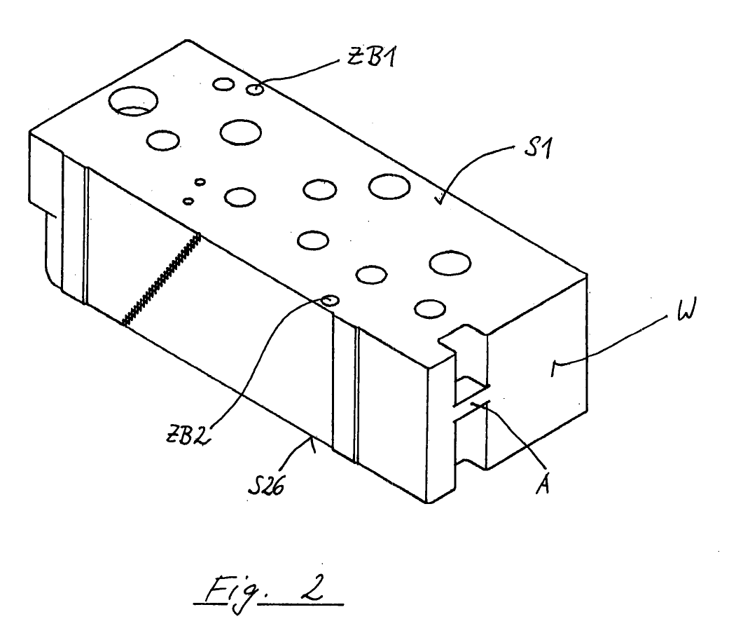

FIG. 2 shows the finished laminated block. In the top segmental plate S1, two fixing borings ZB1 and ZB2 are visible, into each of which a vertically oriented fixing pin extends. The fixing pins can be attached to, e.g., caulked with, the bottom segmental plate S26 and guided through aligned fixing borings in the subsequently stacked segmental plates (not shown). The caulking can be done, for example, by widening a blind hole in the face end of the centering pin.

FIG. 2 also shows, in a side wall W, a stop A which can be located centrally, which is provided so that it comes in contact against a chucking device and can also be used when the laminated block is turned over, i.e., when the segmental plate S26 is on top and the segmental plate S1 on the bottom with respect to FIG. 2. Stops A of this type can also be provided on the other side walls. In one embodiment, the block has a total of three stops A.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the fall breadth of the appended claims and any and all equivalents thereof.

1. A laminated block, comprising:
a plurality of segmental plates stacked one on top of another and connected with one another,
wherein the segmental plates are adhesively connected to one another by high-temperature soldering, and
wherein nickel solder is located flat on the segmental plates prior to the soldering.

2. The laminated block as claimed in claim 1, wherein the laminated block is a hydraulic control valve block.

3. The laminated block as claimed in claim 1, wherein the nickel solder is applied to at least one side of the segmental plates in the form of a paste using a screen printing process.

4. The laminated block as claimed in claim 1, having a solder joint thickness in the range of 10 to 30 microns between adjacent segmental plates that are adhesively connected to one another.

5. The laminated block as claimed in claim 3, having a solder joint thickness in the range of 10 to 30 microns between adjacent segmental plates that are adhesively connected to one another.

6. The laminated block as claimed in claim 1, including a segmental plate provided as a bottom cover plate and connected with at least two vertical fixing pins which are in sliding engagement with fixing borings that are aligned with one another in subsequent segmental plates.

7. The laminated block as claimed in claim 3, including a segmental plate provided as a bottom cover plate and connected with at least two vertical fixing pins which are in sliding engagement with fixing borings that are aligned with one another in subsequent segmental plates.

8. The laminated block as claimed in claim 4, including a segmental plate provided as a bottom cover plate and connected with at least two vertical fixing pins which are in sliding engagement with fixing borings that are aligned with one another in subsequent segmental plates.

9. The laminated block as claimed in claim 6, wherein the fixing pins are caulked with the bottom cover plate.

10. The laminated block as claimed in claim 1, wherein the segmental plates are made of tempered steel.

11. The laminated block as claimed in claim 3, wherein the segmental plates are made of tempered steel.

12. The laminated block as claimed in claim 4, wherein the segmental plates are made of tempered steel.

13. The laminated block as claimed in claim 6, wherein the segmental plates are made of tempered steel.

14. The laminated block as claimed in claim 1, wherein at least one side wall of the laminated block has a stop which is configured to come into contact against a chucking device that acts in a vertical direction, which at least one stop is located between an upper side and the underside of the laminated block.

15. The laminated block as claimed in claim 3, wherein at least one side wall of the laminated block has a stop which is configured to come into contact against a chucking device that acts in a vertical direction, which at least one stop is located between an upper side and the underside of the laminated block.

16. The laminated block as claimed in claim 4, wherein at least one side wall of the laminated block has a stop which is configured to come into contact against a chucking device that acts in a vertical direction, which at least one stop is located between an upper side and the underside of the laminated block.

17. A method of making a laminated hydraulic control valve block, comprising:
providing a plurality of segmental plates;
applying nickel solder to a surface of the segmental plates;
stacking the segmental plates; and
adhesively connecting the segmental plates by high-temperature soldering.

18. The method as claimed in claim 17, including applying the nickel solder in the form of a paste by a screen printing process.

19. The method as claimed in claim 17, including applying the nickel solder to form a solder joint thickness in the range of 10 microns to 30 microns between adjacent segmental plates.

20. The method as claimed in claim 19, including applying the nickel solder to form a solder joint thickness of 20 microns.
